(19) United States
(12) Patent Application Publication
(10) Pub. No.: US 2022/0398535 A1
(43) Pub. Date: Dec. 15, 2022

(54) System and Method for Taxidermy Inventory Management

(71) Applicant: Colton Sharp, Jerico Springs, MO (US)

(72) Inventor: Colton Sharp, Jerico Springs, MO (US)

(21) Appl. No.: 17/705,521

(22) Filed: Mar. 28, 2022

Related U.S. Application Data
(60) Provisional application No. 63/208,677, filed on Jun. 9, 2021.

(51) Int. Cl. G06Q 10/08; G06Q 30/02; G06Q 50/00

(52) U.S. Cl. CPC G06Q 10/0875; G06Q 30/0258; G06Q 50/01

(57) ABSTRACT

The present invention relates to a system and method using a computer implemented application or a website for easily managing taxidermy inventory, tracking trophy animals/mounts and their hides, enhancing business opportunities between taxidermists and customers and allowing hunters (customers) to display their trophy animals or mounts while meeting likeminded individuals. The system uses scannable codes configured to be scanned for tracking associated trophy animals or mounts. The codes are stored in a database and can be matched when scanned for tracking and authenticating the trophy animal. The scannable code system helps keep taxidermists organized and also allows them to update their customers on the status of their trophy. The system is intended to streamline taxidermy and prevent any mix-ups with customers/consumers.

### CROSS-REFERENCE TO RELATED APPLICATION

The present application claims priority to, and the benefit of, U.S. Provisional Application No. 63/208,677 which was filed on Jun. 9, 2021 and is incorporated herein by reference in its entirety.

### FIELD OF THE INVENTION

The present invention relates generally to the field of taxidermy. More specifically, the present invention relates to a system, a method, and an associated computer implement application for effectively managing inventory, increasing business, and tracking trophy animals or mounts by a taxidermist. The invention also allows hunters to upload their trophy animals or mounts, videos, and contents for others to view and also collaborate with taxidermists for enhanced business opportunity. Accordingly, the present disclosure makes specific reference thereto. Nonetheless, it is to be appreciated that aspects of the present invention are also equally applicable to other like applications, devices, and methods of manufacture.

### BACKGROUND

By way of background, taxidermy is the art of preparing, stuffing, and mounting the skins of animals with a lifelike effect for display or for sources of study. Taxidermy can be done on all species of animals including mammals, birds, nematodes, reptiles, and amphibians. Generally, taxidermists manually take the orders from customers and provide them trophy animals or mounts. Often, taxidermists with multiple clients may not be able to tag trophy animals or mounts in a proper way thus delivering wrong hide and other parts to a customer. Further, there is no way of real time tracking of the trophy animals or mounts. This is not only confusing for the taxidermist but can be offending for the customer. Individuals desire a way that they can effectively deliver and track trophy animals or mounts.

Taxidermy as an art and as a community is large. Hunters, taxidermists, and others want to show their work to others but there is not a singular place where individuals can show and preserve their stories, trophy animals, hunting videos, and more. Individuals desire a system that can allow them to build their portfolio and easily showcase same to others.

Taxidermy, as a business, has been around a very long time and taxidermists still perform most of the business manually. Customers who want to purchase trophy animals or mounts have to physically go to a taxidermist to view hide and trophy animals before purchasing. Similarly, hunters who want to sell their hunts cannot easily sell same and typically travel with their trophy animals or mounts for viewing by others. Individuals desire a mechanism that allows both customers and taxidermists to perform business easily.

Taxidermists often find it difficult to manage their inventory and track trophy animals or mounts. Further, manual tracking leads to misplacing of expensive trophy animals or mounts and causes financial loss. Taxidermists use manual tags as identification means however, they are inefficient and consume additional time and effort to locate trophy animals or mounts.

Therefore, there exists a long-felt need in the art for a system that keeps taxidermists organized while ensuring clients receive their proper items. There is also a long-felt need in the art for a way that allows taxidermists to keep customers updated on the status of their animal. Additionally, there is a long-felt need for a system that eliminates manual tracking of trophy animals. Moreover, there is a long-felt need in the art for a taxidermy system that allows taxidermists and customers to easily purchase and sell their taxidermy items. Further, there is a long-felt need in the art for a system that allows individuals to showcase their taxidermy work easily and meet likeminded individuals. Finally, there is a long-felt need in the art for a taxidermy management system that can be easily deployed and used by everyone and provides enhanced opportunity of business and collaboration in the taxidermy community.

The subject matter disclosed and claimed herein, in one embodiment thereof, comprises a taxidermy inventory and tracking system. The system is used by taxidermists to manage inventory while increasing business using a computer implemented application. The system further comprising a server system including a plurality of databases, a plurality of scannable codes attached to respective invoices, boxes, and trophy animals or mounts wherein invoices and boxes associated with a trophy animal have correlated scannable codes allowing tracking of said trophy animal by scanning one or more of the said correlated scannable codes. The computer implemented application is configured to cause one or more processors to receive barcode information from a scanned barcode, displaying trophy animal information associated with the scanned barcode, and updating real time information about the displayed trophy animal.

In this manner, the taxidermy inventory and tracking system and associated method of the present invention accomplishes all of the forgoing objectives and provides a system that features a scannable code applied to the antlers and/or hide to ensure the taxidermist can identify which hide belongs to which animal. The system allows taxidermists to keep customers updated on the status of their animal by simply scanning the barcode and managing the information in a computer software database system. Hunters can upload information regarding their trophies into the system and share it with friends/family. The barcode system helps keep taxidermists organized and prevents mix-ups.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a taxidermy inventory and tracking system. The system is used to provide taxidermists with a method to manage inventory while increasing business using a computer implemented application. The system further comprising a server system including a plurality of databases, a plurality of scannable codes attached to associated invoices, boxes, and trophy animals or mounts wherein invoices and boxes associated with a trophy animal have correlated scannable codes allowing tracking of said trophy animal by scanning one or more of said correlated scannable codes. The computer implemented application is configured to cause one or more processors to receive barcode information from a scanned barcode, displaying trophy animal information associated with scanned barcode, and updating real time information about the displayed trophy animal.

In yet another embodiment, a method for managing inventory of trophy animals or mounts, antlers, and hides in taxidermy is described. The method includes the steps of scanning, by a scanner device, a scannable tag associated with a trophy animal or hide; receiving, by a server, a tag number of said scannable tag; receiving, by a computer implemented application, real time information associated with said trophy animal from the server in response to receiving of the tag number; and receiving, by the server, updated information of said trophy animal wherein the updated information is used for tracking said trophy animal.

In yet another embodiment, a method for tracking taxidermy status of a trophy animal is described. The method includes the steps of receiving, by a server system, a code printed on a barcode of the trophy animal; retrieving, by the server system, information of said trophy animal; and displaying for review of a taxidermist and a customer, by a computer implemented application, said information of the trophy animal.

In yet another embodiment, the server system includes a customer profile database for storing customer information, a taxidermist profile database for storing taxidermist information and a scannable tag database for storing tag information.

In yet another embodiment, the scannable code is one of barcode and/or an alphanumeric string, barcode encoded on Radio Frequency Identification (RFID) tag, or any other variations of linear barcode, two dimensional barcodes, alphanumeric string (e.g., 16-bit string), electronically encoded codes (e.g., 96-bit strings).

In yet another embodiment, the server system is a cloud server system.

In yet another embodiment, the server system is a distributed server system.

In yet another embodiment, the server system is a local server system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of a taxidermy inventory and tracking system of the present invention in accordance with the disclosed architecture;

FIG. 2 illustrates a block diagram view of the server system used in the inventory tracking system of the present invention in accordance with the disclosed architecture;

FIG. 3 illustrates a perspective view of an exemplary taxidermist information label and customer information label used in the taxidermy inventory and tracking system of the present invention in accordance with the disclosed architecture;

FIG. 4 illustrates a perspective view of various tags used for tracking the trophy animal using the tracking system of the present invention in accordance with the disclosed architecture;

FIG. 5A illustrates a perspective view showing a white tag placed on antlers for identification in accordance with the disclosed architecture;

FIG. 5B illustrates a perspective view showing a sealed bag and a customer box used for storing and delivering trophy animals or mounts in accordance with one potential embodiment of the present invention;

FIG. 6 illustrates a flow diagram depicting a process of using barcode tags for tracking ownership of a trophy animal in accordance with the disclosed architecture;

FIG. 7 illustrates a flow diagram depicting a process of managing inventory by a taxidermist using the tracking system of the present invention in accordance with the disclosed architecture;

FIG. 8 illustrates a flow diagram depicting a process of uploading information regarding a trophy animal using the tracking system of the present invention for sale by a taxidermist in accordance with the disclosed architecture;

FIG. 9 illustrates a flow diagram depicting a process of creating advertisements by a taxidermist using the tracking system of the present invention for increasing sales in accordance with the disclosed architecture;

FIG. 10 illustrates an exemplary user interface displayed by the application/website of the present invention to a taxidermist providing a plurality of options to make the taxidermy business smooth and manageable in accordance with the disclosed architecture;

FIG. 11 illustrates a flow diagram depicting a process of using social media features by a customer, the features are provided with the tracking system of the present invention in accordance with the disclosed architecture; and

FIG. 12 illustrates a flow diagram depicting a process of purchasing a trophy animal, a hide, and more by a customer using the application/website of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that keeps taxidermists organized while ensuring clients receive their proper items. There is also a long-felt need in the art for a way that allows taxidermists to keep customers updated on the status of their animal. Additionally, there is a long-felt need for a system that eliminates manual tracking of trophy animals or mounts. Moreover, there is a long-felt need in the art for a taxidermy system that allows taxidermists and customers to easily purchase and sell their taxidermy items. Further, there is a long-felt need in the art for a system that allows individuals to showcase their taxidermy work easily and meet likeminded individuals. Finally, there is a long-felt need in the art for a taxidermy management system that can be easily deployed and used by everyone and provides enhanced opportunity of business and collaboration in the taxidermy community.

The present invention, in one exemplary embodiment, is a novel method for managing inventory of trophy animals or mounts, antlers, and hides in taxidermy. The method includes the steps of scanning, by a scanner device, a scannable tag associated with a trophy animal, antler, or hide; receiving, by a server, a tag number of said scannable tag; receiving, by a computer implemented application, real time information associated with said trophy animal from the server in response to receiving of the tag number; and receiving, by the server, updated information of said trophy animal wherein the updated information is used for tracking said trophy animal.

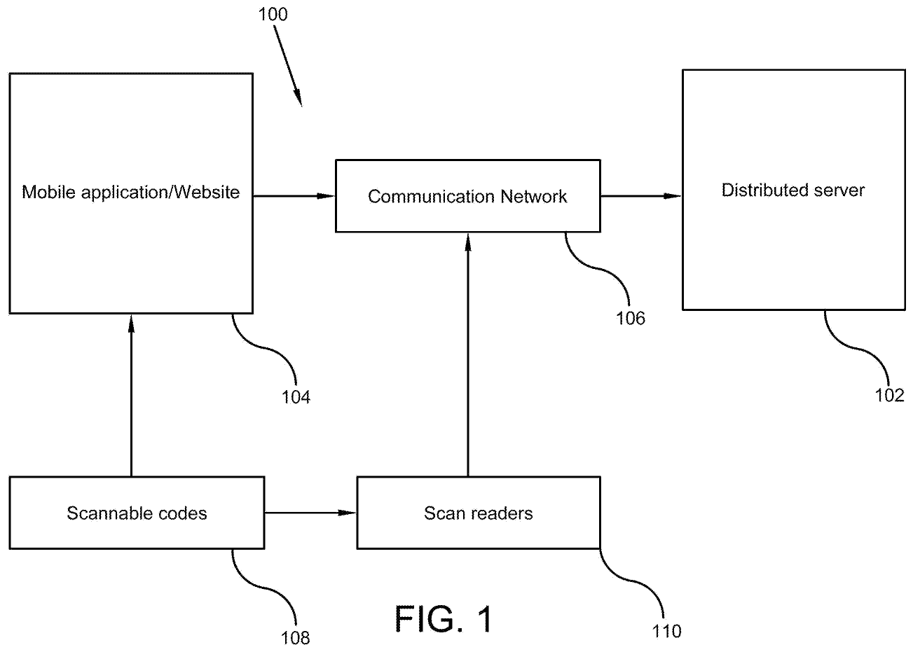

Referring initially to the drawings, FIG. 1 illustrates a schematic view of one potential embodiment of the taxidermy inventory and tracking system of the present invention in accordance with the disclosed architecture. The tracking system 100 of the present invention is designed to allow taxidermists and consumers to easily interact with each other while providing the easy management and tracking of inventory. More specifically, the tracking system 100 uses scannable codes in the form of barcodes, QR codes, or any other scannable code known in the art for scanning and identifying hides, antlers, mounts, and other parts.

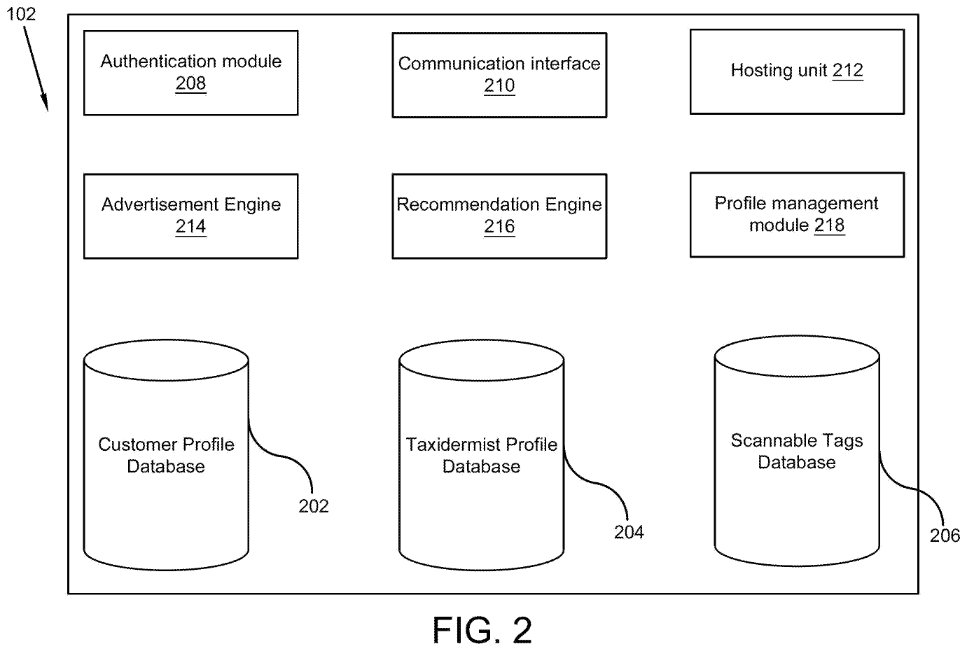

The taxidermy inventory and tracking system 100 includes a computer implemented server 102 which can be in the form of a central server, cloud-based server, or distributed server. Further, details and components of the server 102 are described in FIG. 2 of the present disclosure. A mobile application 104 installed in a user device such as a smartphone, a laptop, a PDA, a smartwatch, and more is used for interacting with the server 102 for accessing functionalities provided by the server 102. A communication network 106 such as internet is used for communication between the mobile application 104 and the server 102. It should be noted that the user interfaces provided by the mobile application 104 are also provided through a website accessed by a user on a browser.

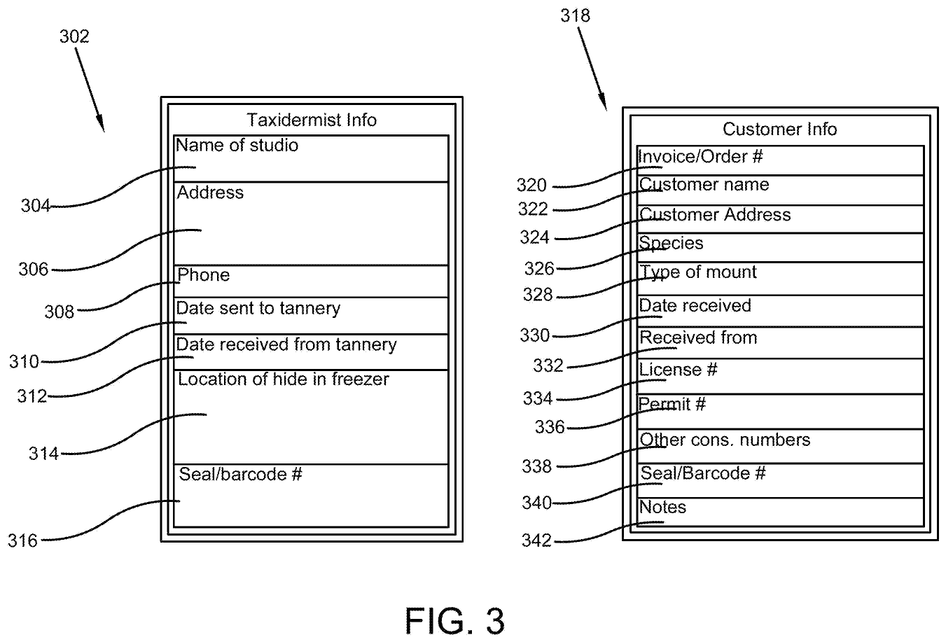

An important aspect and component of the tracking system 100 of the present invention are scannable codes 108 that may be in the form of QR codes, barcodes, or any other conventional codes. The scannable codes 108 are configured to be scanned using an imaging device such as camera of a user's device in which the application 104 is installed. The scannable codes 108 are configured to be removably adhered to hides, horns, antlers, and more of an animal and can be scanned for tracking and viewing information associated with the codes 108. It should be understood that system 100 includes a plurality of correlated scannable codes and labels as shown in FIGS. 3 & 4 that can be used by both taxidermist and consumers for tracking their trophy and taxidermy mount.

In addition to the mobile application 104 for scanning scannable codes 108, the tracking system 100 provides portable scan readers 110 that are configured to scan and read scannable codes 108, thereby helps in tracking the animal trophy and hide. The scan readers 110 are configured to read barcodes, QR codes and more and communicate with the server 102 using the communication network 106. Further, the scan readers 110 are specifically provided to taxidermists allowing them to easily scan the codes of their trophy animals or mounts in a proper way.

The taxidermy inventory and tracking system 100 is designed to create a foolproof system for tracking trophy animals or mounts where the correlated scannable codes are adhered to different parts of an animal trophy. The tracking system 100 provides a simple way for taxidermists to manage their business by providing customers the correct animal trophy, and tracking an animal trophy and its parts through delivery and freezing. The application 104 can be used for issuing invoice and receiving payments from customers.

For consumers, the application 104 provides a social media platform for uploading their stories, chat with like-minded individuals, placing their animal trophy up for sale, searching for animal trophies or mounts to buy, and more. Therefore, the tracking system 100 provides a combination of inventory management for taxidermists and a taxidermist community platform for users as described later in the disclosure.

The application/website 104 is configured to provide different interfaces to a user when logged into the application/website 104 as a taxidermist and when logged in as a consumer/user. The advantage of the application/system 104 of the tracking system 100 is providing a seamless interaction for promoting business while allowing tracking of the animal trophies or mounts.

The communication network 106 may include suitable logic, circuitry, and interfaces that may be configured to provide a plurality of network ports and a plurality of communication channels for transmission and reception of data related to operations of various entities (such as the user device in which the application is installed or website is accessed and the server system 102) of the trophy saver system 100. The communication network 106 may be associated with an application layer for implementation of communication protocols based on one or more communication requests from the application/website 104 and the server system 102. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel of a plurality of communication channels in the communication network 106. The communication channels may include, but are not limited to, a wireless channel, a wired channel, a combination of wireless and wired channels thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Metropolitan Area Network (MAN), a satellite network, the internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

FIG. 2 illustrates a block diagram view of the server system 102 used in the tracking system 100 of the present invention in accordance with the disclosed architecture. The server system 102 can be a network of computers, a software framework, or a combination thereof, that may provide a generalized approach to create the server implementation. More specifically, the server 102 is coupled with a plurality of distributed databases for storing relevant information of users, taxidermists, and scannable codes for a central management of data. Also, it should be appreciated, that the distributed databases can be managed by a plurality of servers of the server system 102.

A customer profile database 202 is configured to store profile data of users logged in as customers in the application/website 104 of the tracking system 100. The database 202 stores personal information of a customer including, but not limited to, name, gender, age, interests, location, email address, trophy information and more. The taxidermist profile database 204 is used for storing information of taxidermists subscribed to the tracking system 100. The taxidermist information stored in the database 204 may include, but not be limited to, studio name, address, contact information, animal trophy information offered by the taxidermist, and more.

A scannable tags database 206 can be a central database or alternatively can be a local database located at a taxidermist studio and is configured to store correlated tags information. The code encoded on the scannable codes can be stored in the database 206 and is used for correlating an animal trophy with a scannable code. In use, when a scannable code is scanned and read, the correlating information from the database is also retrieved for authentication of the tag.

It should be understood that the tracking system 100 of the present invention is configured to provide a plurality of functionalities and the server system 102 includes a plurality of software and hardware modules for providing the functionality through scannable tags/codes 108 and the application/website 104. An authentication module 208 is used for authenticating a taxidermist or a customer during logging into the tracking system 100. The authentication module 208 is configured to authenticate user name and password received by comparing with the user name and password stored in the databases 202,204.

A communication interface 210 may include suitable logic, circuitry, and interfaces that may be configured to establish and enable a communication between the server 102 and different components of the tracking system 100 such as the application/website 104, via the communication network 106. A hosting unit 212 is configured to generate user interfaces on the trophy save application/website 104 for enabling users to access the tracking system 100. The hosting unit 212 may further include a web server (preferably implemented in software executed by the hosting unit 212) to generate a web page that contains one or more pictures/images. The web server is also capable of receiving information from a user entered into a web page and process that information.

An advantage of the tracking system 100 of the present invention is that taxidermists can create advertisements to increase their business and upload on the advertisement engine 214, thereby allowing customers of the application/website to view advertisements. The recommendation engine 216 is used by the advertisement engine 214 for targeting advertisements to customers based on a variety of parameters including, but not limited to, location, gender, interests, age, and more. The recommendation engine 216 is configured to use the customer profile data stored in the customer database 202 and taxidermist profile of the taxidermist running the advertisement stored in the database 204 for providing recommendations.

A profile management module 218 is used for managing and updating profiles of both customers and taxidermists. When a profile is updated on the application/website, the profile management module 218 updates the information in the databases 202,204. Further, for tracking inventory of trophy animals or mounts, scannable codes information is updated in the scannable tags database 206 using the profile management module 218.

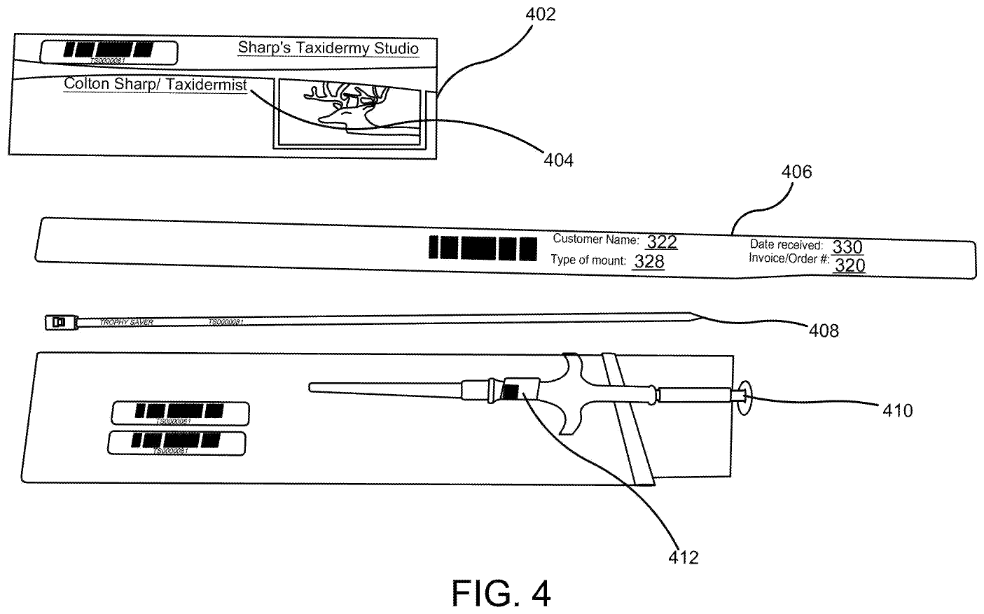

FIG. 3 illustrates a perspective view of an exemplary taxidermist information label and customer information label used in the taxidermy inventory and tracking system of the present invention in accordance with the disclosed architecture. For tracking the repository, processing and delivery of trophy animals or mounts and their components, the system provides a taxidermist information label 302 that can be removably attached to a hide of an animal. The taxidermist information label 302 is used for providing primary information required to track the trophy animal. As illustrated, the label 302 includes the taxidermist studio name 304, address 306, phone number 308, date when the hide/animal is sent to tannery 310, date when the hide/animal is received from a tannery 312, location of hide in freezer 314, and barcode number 316 written on the tag (shown in FIG. 4) attached to the hide/animal. It should be noted that the aforementioned information can be filled out by a taxidermist using the application/website 104 and then can be printed and adhered to the hide/animal. The taxidermist information label 302 when adhered to hide can be used for tracking the historical processing and taxidermist information related to the hide. Also, a customer can use the barcode number to identify additional information about the hide from the databases as described in FIG. 2. The taxidermist information can be retrieved using the barcode number and therefore, provides an easy mechanism of tracking taxidermist of a trophy animal.

A customer information label 318 is also configured to adhere on the hide and is used for tracking the customer and is especially useful for delivering the hide to a customer or receiving a hide from a customer. The customer information label 318 has invoice or order number 320 for uniquely identifying the hide. The label 318 further has the customer name 322 who has purchased/sold the hide, customer address 324, species of the trophy animal 326, type of mount 328, date received 330, received from tab 332 indicating name of a person or agent, license number 334 of taxidermist, permit number 336 of the customer, any other consignment numbers 338, barcode 340 which can be same as the barcode/tag 316 of the taxidermist information label 302. Any additional notes 342 may also be incorporated in the customer information label 318.

It should be noted that all the information included in the taxidermist information label 302 and the customer information label 318 are stored in the databases of the server system 102 and can be retrieved using the application/website as per desire and preference of the taxidermist and customer.

FIG. 4 illustrates a perspective view of various tags used for tracking the trophy animal using the tracking system 100 of the present invention in accordance with the disclosed architecture. A label 402 is used for providing an overview of the taxidermist studio and can be affixed on a box carrying the hide/trophy animal. The label 402 includes the barcode tag 316 that can be easily scanned using application/website or readers for retrieving trophy animal information. The label 402 also carries the general information 404 of the taxidermist studio which is delivering, processing, or purchasing the hide/trophy animal stored in the box on which the label 402 is affixed. The general information 404 may include studio name, address, contact number and email ID.

A white tag 406 is placed on horns or antlers of a trophy animal and has the same barcode number as of the label 402 affixed to the box in which the trophy animal is stored. The correlated tags allow a person to easily authenticate the trophy animal as the same barcode number is also affixed or written on the customer label (as shown in FIG. 3). More specifically, the white tag 406 has the barcode, customer name 322, type of mount 328, date received 330, and invoice number 320. An orange zip tie tag 408 is configured to tie to hide. The orange tie tag 408 also has the barcode number that can be used for tracking the hide/trophy animal.

An implant 410 is placed into hide and functions as a registration number 412 that can be scanned to identify the owner taxidermy shop of the trophy animal.

It should be noted that invoice, taxidermist information label, customer information label, trophy animal, and all the tags related to a hide/trophy animal have the same and correlated barcode or tag and can be used for tracking throughout the cycle of the trophy animal processing, selling, and purchasing.

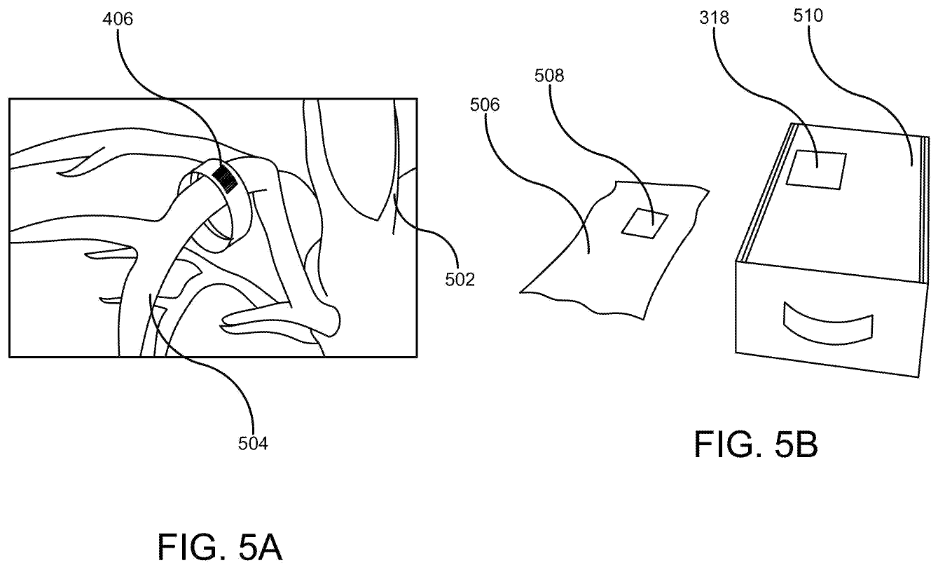

FIG. 5A illustrates a perspective view showing the white tag 406 placed on antlers for identification in accordance with the disclosed architecture. As illustrated, the white tag 406 is removably attached on the antlers 504 of a trophy animal 502 wherein the white tag 406 can be scanned by a taxidermist to keep customers updated on the status of their trophy animal. Further, the white tag 406 has customer information eliminating misdelivery of the trophy animal 502.

FIG. 5B illustrates a perspective view showing a sealed bag and a customer box used for storing and delivering trophy animal in accordance with one potential embodiment of the present invention. As illustrated, the tracking system 100 of the present invention uses a vacuum sealed bag 506 for storing hide and placing in a freezer chest. The vacuum sealed bag 506 preserves the hide and also occupies less space. The vacuum sealed bag 506 has the barcode tag 508 affixed thereon wherein the barcode tag 508 is correlated with other tags associated with the hide.

A carrying box 510 is used for storing and delivering the trophy animal and/or hide. The vacuum sealed bag 506 can be stored inside the carrying box 510 and the box 510 also has the customer information label 318 for easily identifying the customer.

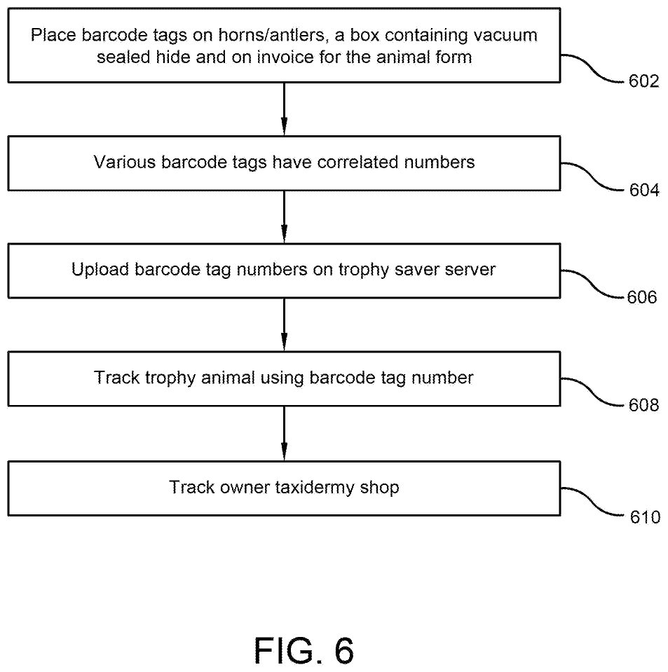

FIG. 6 illustrates a flow diagram depicting a process of using barcode tags for tracking ownership of a trophy animal in accordance with the disclosed architecture. Initially, barcode tags are placed or affixed on horns/antlers of a trophy animal. Similarly, barcodes are also placed on the vacuum sealed bag, carrying box, implant and invoice related to the trophy animal (Block 602). It should be noted that all the boxes associated with a trophy animal/hide have correlated tags allowing a taxidermist and a customer to easily track trophy animal/hide. The various barcode tags are correlated and are used for tracking (Block 604). Thereafter, for centralized tracking and monitoring, the barcode tag is uploaded on the server system using application/website (Block 606).

On preference and requirement of a user, the trophy animal is tracked at various stages of processing of the trophy animal/hide using the barcode tags (Block 608). Using the barcode tag, ownership of the taxidermist studio can also be determined by other taxidermists and customers (Block 610).

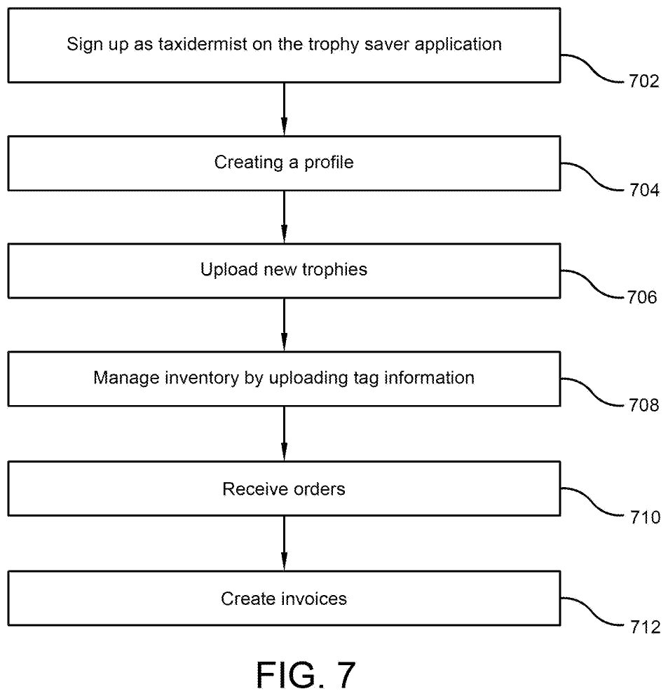

FIG. 7 illustrates a flow diagram depicting a process of managing inventory by a taxidermist using the tracking system 100 of the present invention in accordance with the disclosed architecture. As illustrated, initially, a taxidermist signs up on the system using the application/website (Step 702). Thereafter, a profile is created by the taxidermist that may include studio name, address, contact information, inventory and more (Step 704). Thereafter, the inventory can be updated by the taxidermist by uploading and adding new trophy animals or mounts and other accessories and also by removing trophy animals or mounts that are no longer available (Step 706).

In Step 708, the taxidermist scans the tags associated with the trophy animals or mounts/hides for uploading and reviewing the information, thereby managing the inventory. Then, orders may be received by the taxidermist from customers using the tracking system 100 for purchasing the trophy animals or mounts, hides and more (Step 710). Finally, using the application/website 104, invoices are created and tracked by the taxidermist using the tracking system 100 of the present invention (Step 712).

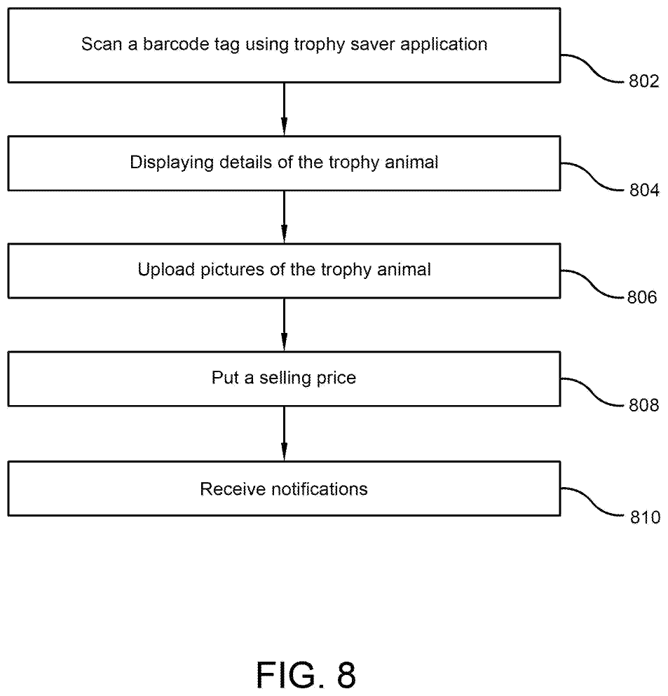

FIG. 8 illustrates a flow diagram depicting a process of uploading a trophy animal using the tracking system 100 of the present invention for sale by a taxidermist in accordance with the disclosed architecture. As shown, initially, a barcode placed on a hide/trophy animal is scanned by trophy saver application/website 104 or using a scanner (Step 802). Thereafter, details of the associated trophy animal/hide are displayed on the application/website (Step 804). Additional details and description may be added by the taxidermist. Then, photos of the trophy animal/hide are uploaded to the server system (Step 806). When for sale, a sale value is associated by the taxidermist wherein the details, photos and sale value are configured to be viewable by potential buyers (Step 808). The tracking system 100 is configured to provide push notifications which are received by the taxidermist and thus helps in easy selling and increasing business of the taxidermist (Step 810).

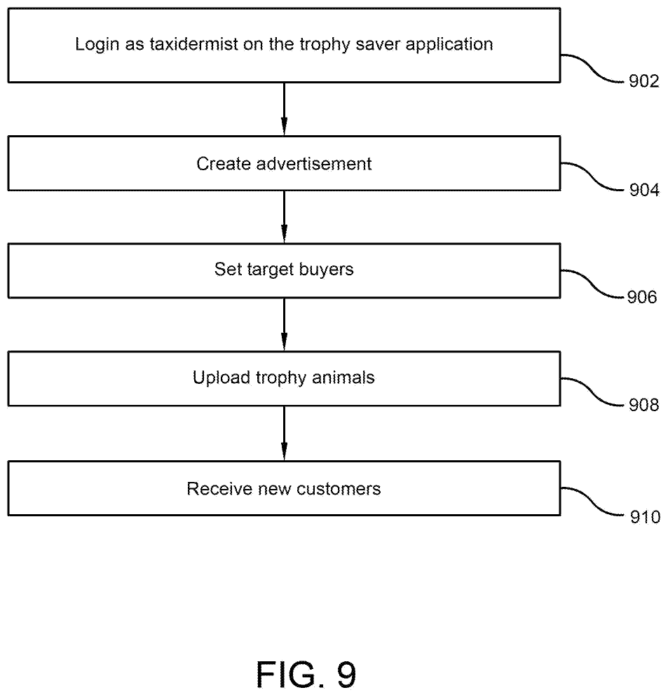

FIG. 9 illustrates a flow diagram depicting a process of creating advertisements by a taxidermist using the tracking system 100 of the present invention for increasing sales in accordance with the disclosed architecture. As illustrated, initially, a taxidermist logs in on the system using the application/website (Step 902). Thereafter, an advertisement is created by the taxidermist that may include a trophy animal, sale price, description, and more (Step 904). Thereafter, the target buyers may optionally be selected by the taxidermist (Step 906). Based on the advertisement parameters, the recommendation engine of the system recommends the advertisement to target customers on the tracking system 100 thereby allowing customers to buy and thus increase sales of the taxidermist.

In Step 908, new trophy animals or mounts are uploaded that are associated with the advertisement. Based on the advertisements, the taxidermist receives new customers using the recommendation engine and thus business of taxidermists can be improved by the tracking system 100 (Step 910).

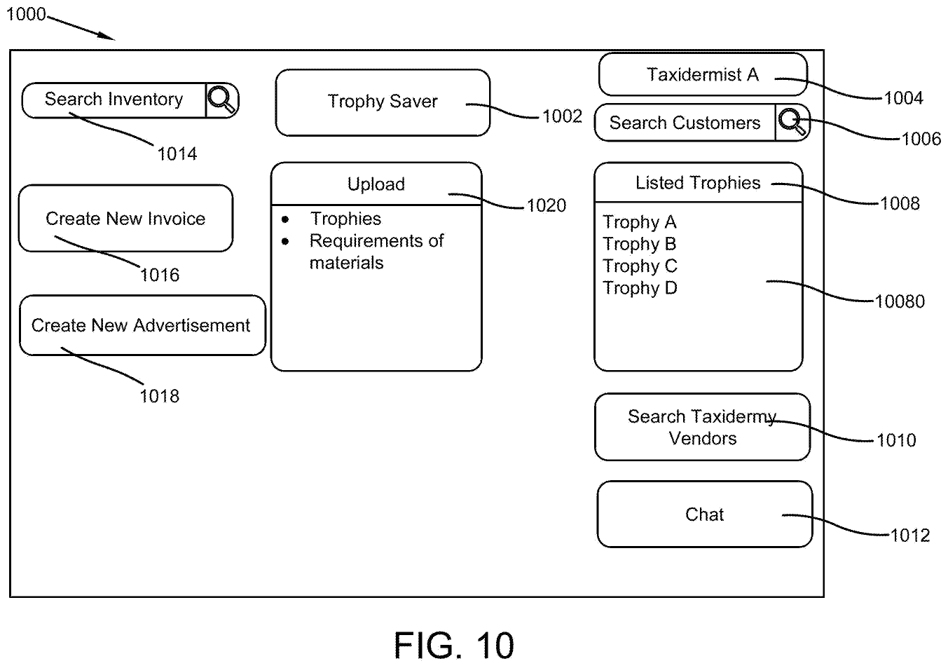

FIG. 10 illustrates an exemplary user interface displayed by the application/website of the present invention to a taxidermist providing a plurality of options to make the taxidermy business smooth and manageable in accordance with the disclosed architecture. As illustrated, the user interface 1000 displays a logo “Trophy saver” 1002 on top of the interface 1000. Taxidermist “A” 1004 is logged in to the application/website and information on the interface 1000 is tailored to the profile of the Taxidermist “A” 1004.

A search customer bar 1006 is provided that allows the taxidermist 1004 to search for potential customers based on a number of parameters like location, name, preferences and more. Listed trophies section 1008 displays a list 10080 of trophy animals and mounts listed and uploaded by the taxidermist 1004. The list 10080 is displayed to customers of the system for purchase. It is to be appreciated that listed trophies include taxidermy mounts of hides, pelts, birds, fish, horns, antlers, mammals, reptiles, and more.

The search taxidermy vendors tab 1010 allows the taxidermist 1004 to search for potential taxidermy vendors listed in the system. This allows the taxidermist 1004 to easily locate desired taxidermy vendors. A chat tab 1012 allows the taxidermist 1004 to chat with potential customers and other vendors listed on the system.

For managing inventory, a search inventory tab 1014 is provided to the taxidermist 1004. A search can be performed using the name of the trophy animal or using a barcode tag. The interface 1000 provides the capability of generating new invoices for an order using the create new invoice tab 1016. An invoice template may be generated with pre-filled information for quickly generating an invoice.

As stated in FIG. 9, a taxidermist can create advertisements for increasing sales using the application/website. Accordingly, the taxidermist 1004 can use the create new advertisement tab 1018 for generating a new advertisement to promote products and create awareness among customers. The upload button 1020 allows the taxidermist 1004 to upload trophy animals or mounts and requirement of taxidermy materials.

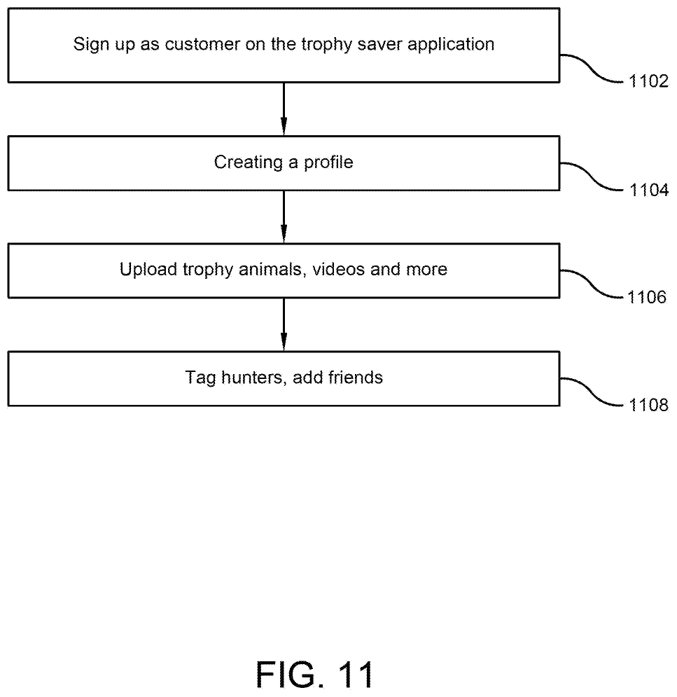

FIG. 11 illustrates a flow diagram depicting a process of using social media features by a customer, the features are provided in the tracking system 100 of the present invention in accordance with the disclosed architecture. Initially, a user signs up as a customer or consumer on the trophy save application/website (Step 1102). Thereafter, in Step 1104 the customer or consumer creates a profile and provide profile attributes including, but not limited to, name, gender, age, interests, location, email address, trophy information, and more. Then, trophy animals, videos, photos, stories, and more are uploaded by the customer (Step 1106). In Step 1108, the customer or consumer can use social media features offered by application/website to tag fellow hunters and like-minded individuals (i.e., friends). It should be noted that although Steps 1106,1108 are shown as separate steps, inherently they can be performed simultaneously or in reverse order.

The customer/user can share, comment, tag other users, purchase hunting/fishing equipment from companies that advertise on the tracking system 100. The user can also upload videos of hunts and fishing adventures for other individuals to enjoy and get inspiration.

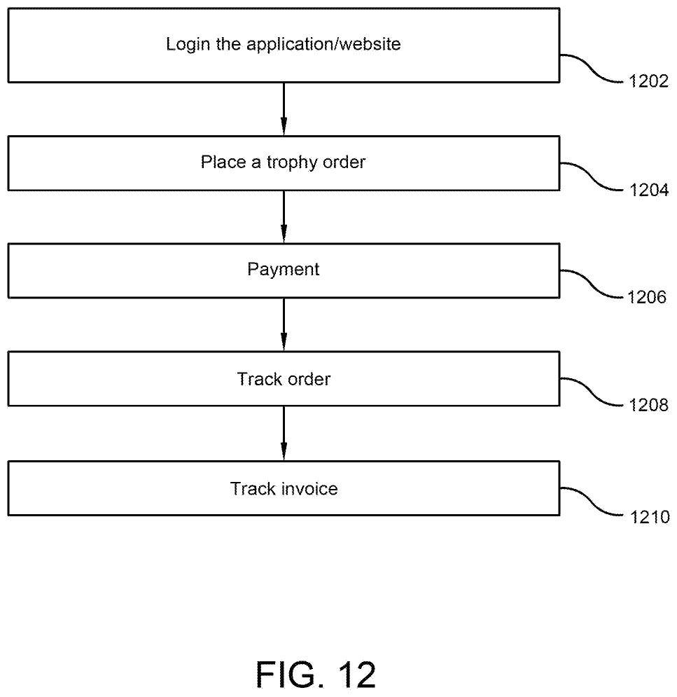

FIG. 12 illustrates a flow diagram depicting a process of purchasing a trophy animal, a hide, mount, and more by a customer using the application/website of the present invention in accordance with the disclosed architecture. Initially, a user logs in as a customer on the trophy save application/website (Step 1202). Then, the user places an order for a trophy animal, a hide, or any other offering offered by a seller (Step 1204). Thereafter, a payment is made by the user for the placed order (Step 1206). Using the scannable tags associated with the order, the order can be tracked by both the taxidermist (seller) and user (customer) (Step 1208). Finally, the taxidermist (seller) and user (customer) can track the invoice and the order for easy processing and delivery of the ordered trophy animal, hide, pelt, bird, horn, and antler (Step 1210).

As used herein, the term “server” or “server system” refers to any computerized component, system, or entity regardless of form which is adapted to provide data, files, applications, content, or other services to one or more other devices or entities on a computer network.

As used herein, the term “user interface” refers to, without limitation, any visual, graphical, tactile, audible, sensory, or other means of providing information to and/or receiving information from a user or other entity.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “system”, “taxidermy inventory and tracking system”, “tracking system”, and “trophy saver system” are interchangeable and refer to the taxidermy inventory and tracking system 100 of the present invention. Similarly, as used herein “software application”, “application”, and “trophy saver application” are interchangeable and refer to the trophy saver application 104 of the present invention.

Notwithstanding the forgoing, the taxidermy inventory and tracking system 100 and the trophy saver application 104 of the present invention can be of any suitable size and configuration as is known in the art without affecting the overall concept of the invention, provided that it accomplishes the above-stated objectives. One of ordinary skill in the art will appreciate that the taxidermy inventory and tracking system 100 and the trophy saver application 104 as shown in the FIGS. are for illustrative purposes only, and that many other sizes and shapes of the taxidermy inventory and tracking system 100 and the trophy saver application 104 are well within the scope of the present disclosure. Although the dimensions of the taxidermy inventory and tracking system 100 and the trophy saver application 104 are important design parameters for user convenience, the taxidermy inventory and tracking system 100 and the trophy saver application 104 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inventory tracking system for a taxidermy business, the inventory tracking system comprising:
a series of scannable codes for scanning and identifying a taxidermy mount;
a computer server selected from a group consisting of a central server, a cloud-based server and a distributed server;
an application installed in a user device for interacting with said computer server;
a communication network for communicating between said mobile application and said computer server;
wherein said user device includes an imaging device for scanning said scannable codes;
wherein said scannable codes are removably adhered to said taxidermy mount for tracking and viewing information associated with said taxidermy mount;
said information correlated to said taxidermy mount accessed by the taxidermist and a consumer for tracking said taxidermy mount;
wherein said taxidermist access provides for status of said taxidermy mount; and
further wherein said consumer access provides a social media platform for uploading stories, videos, and photos regarding said taxidermy mount.

2. The inventory tracking system of claim 1, wherein said consumer access provides for offers for sale and for offers for purchase of said taxidermy mount.

3. The inventory tracking system of claim 2, wherein said taxidermy mount is selected from a group consisting of a hide, a pelt, a bird, a fish, a horn, an antler, a mammal, and a reptile.

4. The inventory tracking system of claim 1, wherein said scannable codes are selected from a group consisting of a barcode, and a QR code.

5. The inventory tracking system of claim 4, wherein said user device is selected from a group consisting of a smartphone, a laptop, a PDA, and a smartwatch.

6. The inventory tracking system of claim 5, wherein said application is a mobile application.

7. The inventory tracking system of claim 6, wherein said application issues invoices to said consumer and receives payments from said consumer.

8. The inventory tracking system of claim 7, wherein said communication network is an Internet network.

9. An inventory tracking system for a taxidermy business, the inventory tracking system comprising:
a series of scannable codes for scanning and identifying a taxidermy mount;
a computer server selected from a group consisting of a central server, a cloud-based server, and a distributed server;
an application installed in a user device for interacting with said computer server;
a communication network for communicating between said mobile application and said computer server;
wherein said user device includes an imaging device for scanning said scannable codes;
wherein said scannable codes are removably adhered to said taxidermy mount for tracking and viewing information associated with said taxidermy mount;
said information correlated to said taxidermy mount accessed by the taxidermist and a consumer for tracking said taxidermy mount;
wherein said taxidermist access provides for status of said taxidermy mount; and
further wherein said taxidermy mount is selected from a group consisting of a hide, a pelt, a bird, a fish, a horn, an antler, a mammal, and a reptile

10. The inventory tracking system of claim 9, wherein said consumer access provides for offers for sale and for offers for purchase of said taxidermy mount.

11. The inventory tracking system of claim 9, wherein said scannable codes are selected from a group consisting of a barcode, and a QR code.

12. The inventory tracking system of claim 11, wherein said consumer access provides a social media platform for uploading stories, videos, and photos regarding said taxidermy mount.

13. The inventory tracking system of claim 12, wherein said user device is selected from a group consisting of a smartphone, a laptop, a PDA, and a smartwatch.

14. The inventory tracking system of claim 13, wherein said application is a mobile application.

15. The inventory tracking system of claim 14, wherein said application issues invoices to said consumer and receives payments from said consumer.

16. The inventory tracking system of claim 15, wherein said communication network is an Internet network.

17. An inventory tracking system for a taxidermy business, the inventory tracking system comprising:
a series of scannable codes for scanning and identifying a taxidermy mount;
a computer server selected from a group consisting of a central server, a cloud-based server, and a distributed server;
an application installed in a user device for interacting with said computer server;
a communication network for communicating between said mobile application and said computer server;
wherein said user device includes an imaging device for scanning said scannable codes;
wherein said scannable codes are removably adhered to said taxidermy mount for tracking and viewing information associated with said taxidermy mount;
said information correlated to said taxidermy mount accessed by the taxidermist and a consumer for tracking said taxidermy mount;
wherein said taxidermist access provides for status updating of said taxidermy mount;
wherein said consumer access provides for status checking of said taxidermy mount; and
further wherein said taxidermist access provides for advertisement distribution.

18. The inventory tracking system of claim 17, wherein said taxidermy mount is selected from a group consisting of a hide, a pelt, a bird, a fish, a horn, an antler, a mammal, and a reptile.

19. The inventory tracking system of claim 18, wherein said consumer access provides for offers for sale, offers for purchase, and tagging of friends of said taxidermy mount.

20. The inventory tracking system of claim 19, wherein said consumer access provides a social media platform for uploading stories, videos, and photos regarding said taxidermy mount.
